(19) United States
(12) Patent Application Publication
(10) Pub. No.: US 2013/0136849 A1
(43) Pub. Date: May 30, 2013

(54) SUB-MICRON COMPOSITIONS

(71) Applicant: Nigel Paul Maynard, Waitakere (NZ)

(72) Inventor: Nigel Paul Maynard, Waitakere (NZ)

(73) Assignee: MATTERSMITHS TECHNOLOGIES LIMITED, Waitakere (NZ)

(21) Appl. No.: 13/813,001

(22) PCT Filed: Aug. 1, 2011
(86) PCT No.: PCT/NZ2011/000146

§ 371 Date: Jan. 29, 2013

(30) Foreign Application Priority Data
Jul. 30, 2010 (NZ) 587127

(51) Int. Cl. A01N 25/08; A01N 37/34; A01N 53/00; A01N 59/20; A01N 43/653

(52) U.S. Cl. CPC A01N 25/08; A01N 59/20; A01N 43/653; A01N 53/00; A01N 37/34
USPC 427/4; 424/409; 424/417; 424/633; 424/634; 514/383; 514/531; 427/212; 427/294; 427/421.1; 427/429; 427/430.1; 427/297; 427/295; 427/427.7; 427/435; 427/440; 427/443.2

(57) ABSTRACT

The invention relates to sub-micron compositions, and methods of preparing such compositions, in particular for the treatment of substrates against biological degradation biological pests.

### TECHNICAL FIELD

The invention relates to sub-micron compositions, and methods of preparing such compositions, in particular for the treatment of substrates against biological degradation or biological pests.

### BACKGROUND

There are known methods for preparing compositions to treat a substrate. These methods may vary depending on the nature of the substrate to which a composition is to be applied, and whether or not the composition is required to penetrate the surface of the substrate. Many of these known methods include as examples true solutions of biocides, suspensions or micro-suspensions of biocides, encapsulated biocides and emulsions or micro-emulsions of biocides. The following background discussions outline, by way of example, techniques used to prepare compositions for delivery to substrates.

Lignocellulosic materials, such as lumber for example, are generally treated with biocides subsequent to the felling and milling of trees in an attempt to extend their service life. Living plants are generally treated whilst growing to encourage health and to promote good crop yields. Natural leather obtained from animals is often treated subsequent to the processing of a carcass for meat. All such substrates, being organic, are subject to attack by degrading organisms such as bacteria, fungi and insects. In the case of plants, this can result in potential income losses through a reduction in crop yield. Inorganic substrates such as the surface of painted objects and concrete, can also be subject to degradation. Such attack reduces the service life of these substrates, degrades their appearance, and results in cost of replacement or potential hazard due to failure.

To mitigate infection or infestation by degrading organisms methods have been developed to treat organic and inorganic substrates with a variety of chemicals by various physical processes using products of differing properties. Unfortunately, these products may be considered to have one or more disadvantages.

For example, lignocellulosic substrates are complex structures including wood cells interconnected by pits which include a membrane otherwise acting as a valve system when the tree is living. When trying to treat the interior of this substrate, such cells and cell interconnections offer impedance to the flow of preservative into the substrate. This is more particularly so when the substrate is dry because the pit membranes aspirate, that is they collapse to either side of the pit and effectively seal it shut. Drying of the substrate, however, is important prior to treatment with preservative because space is required within which to place the preservative.

Certain modern preservatives for lumber include the likes of ammoniacal copper quaternary and copper azoles. These both require addition of ammonia or amines to solubilise the copper component. Ammonia is a toxic gas which in addition to cost is a hazard to workers. Amines have been used to replace ammonia but these exacerbate cost further.

With regard to the treatment of plant substrates care must be taken not to include phytotoxic components. For example, an insecticide or fungicide for application to a living plant must not contain excessive levels of organic solvents such as xylene because this could cause plant death.

Broadly speaking, many current technologies for the treatment of substrates against degrading organisms include components, other than the selected biocide, which can be flammable, toxic, and environmentally hazardous. Such components contribute to the overall cost of the compositions employed. Consequently, during the past decade alternatives have been developed but many of these fail to adequately overcome issues of toxicity and cost.

For example, NZ 280716 teaches use of a preservative composition wherein the biocide is in the form of a colloid. The technique uses anhydrous quaternary ammonium compounds or tertiary amine oxides to solubilise otherwise insoluble biocides in the presence of aprotic solvents followed by dilution in water to form colloidal biocides. However this art is too expensive for the majority of purposes and when used on plants, may be too phytotoxic. GB 387819 also teaches use of a preservative composition comprising colloidal arsenic trisulphide for use in preserving wood. However, arsenic compounds are now prohibited from general use due to their toxicity.

Sub-micron biocides prepared by the milling or micronising technique were described in the Proceedings of the Fourth International Congress of Pesticides Chemistry (IUPAC) 1978. These proceedings teach physical stability of pesticidal dispersions stating “These dispersions are always polydispersed with particle sizes in the range of 0.1 μm to 5 μm.” Thus the particle size ranges from 100 nm to 5000 nm.

U.S. Pat. No. 4,142,009 teaches use of a colloidal pigment conveyed in an organic solvent for the preservation of timber. However, solvents are being phased out due to environmental destruction arising from the loss of solvent to the atmosphere after use. Solvents are also expensive, which is a further disadvantage for some formulations.

U.S. Pat. No. 6,113,936 teaches use of a composition wherein the biologically active substance is micro-encapsulated. While micro-encapsulation is an effective mechanism for preparing biocides, manufacturing plants are capital intensive and ancillary materials used in the composition can contribute significantly to cost.

US 20030072807 teaches an antifungal composition wherein sub-micron to micron sized particles are coated with at least one surfactant, such particles having been prior formed by precipitation from an organic solvent upon contact with water, followed by coating with surfactant. Similarly US 2003206959 teaches a similar process. However, the required solvents for the process contribute significantly to the costs of this process, as does the requirement for high levels of surfactants and dispersants.

Further alternatives developed in the past decade include: U.S. Pat. No. 6,521,288, which teaches treatment of lumber with nano-particles based on polymeric organic materials; US 2006115506, which teaches a method of preserving wood with colloidal silica or colloidal alumina; U.S. Pat. No. 6,015,816, which teaches control of microbial growth on HEPA filters using clays chemically modified with quaternary ammonium compounds (the clays can be further modified by addition of other biologically active species); US 20032134137, which teaches use of nano-particles prepared in accordance with U.S. Pat. No. 6,113,936 wherein the particles are prepared as a micro-emulsion but wherein a polymer is co-dissolved and precipitated as a biocide polymer combination; and US 20070259016 which teaches the use of sub-micron fungicides achieved by milling or grinding with zirconia balls.

Many soluble copper based preservative systems require the use of ammonia and amines. However, due to their cost and hazardous nature, various prior art has taught the preparation of micronized biocides using grinding mills. For example, US 20080199525 teaches use of micronized biocides as wood preservatives wherein such biocides are prepared by milling using the likes of zirconia balls. This is designed to eliminate inclusion of costly and potentially toxic components such as ammonia or amines. Similarly, WO2007002156 describes a wood preservative prepared by grinding biocides in a ball mill in the presence of suitable dispersants. Use of dispersants prevents an increase in particle size through what is known in the art as Ostwald ripening. However, frequently high loadings of dispersants are required in such processes to prevent agglomeration and settling of particles in the sub-micron compositions. The use of dispersants therefore increases the overall cost of the composition, particularly when high loadings are required.

The use of milling or grinding processes have their own associated problems. On a commercial scale equipment is capital intensive and can cost several million dollars. Energy costs are high, cooling costs are high and replacement grinding media is expensive. As indicated above, costly dispersants and surfactants may also be required. Further, because of the capital required, large plants need to be built to focus manufacture in key positions. This allows higher throughput through each plant to amortise capital costs, but leads to high transport costs for the finished products to geographically more remote users. In addition grinding is a very slow process exacerbating manufacturing times.

As indicated above, biocides typically form part of the compositions used to treat a substrate against biological degrade or biological pests. Some biocide particles can be abrasive. For example, particles of basic copper carbonate wear zirconia milling media when the latter is used in a grinding process, hence the requirement for replacement of such media at considerable cost. However this can have further consequences. Such particles can wear pumps, pipes and valves used in equipment for application, for example, in a wood preservation plant.

Some concern has been expressed over micronized biocides in that a considerable portion of the biocide is hidden within the particle structure that is the only immediately available biocide is the outer shell. This could be problematic. For example, some fungi can deactivate copper biocides by insolubilising or sequestering them by excreting oxalic acid. If a particulate copper biocide, as opposed to a molecular biocide, were used the fungi would be required to produce less overall oxalic acid because much of the biocide would be sequestered or encapsulated and therefore immobilised inside an insoluble shell of copper oxalate. By comparison, a sub-micron biocide comprising a monomolecular outer layer on a substrate would require stoichiometric amounts of oxalic acid.

Sometimes it is advantageous to attach biocides to target substrates during preparation of the biocide composition. For example, one might wish to coat the seeds of plants with a fungicide or insecticide such that they are resistant to attack prior to germination.

Whilst biocides should preferably remain insoluble in or on the substrate, trace amounts must be available biologically. However, if insoluble particles or capsules are unable to release all available biocide, efficiency will decline. It is preferably that all biocide becomes available for use. This difficulty might occur in certain cases of micro-encapsulation as well.

The above description and examples highlight the problems associated with known products for treatment or impregnation of organic substrates with such biocide compositions. Problems may include one or more of: necessity to use expensive plant and manufacturing equipment; large plant and processing equipment; extended processing times; excessive environmental impact; excessive energy requirements; abrasiveness and/or use of costly non-biocidal ancillary chemicals.

### OBJECT OF THE INVENTION

It is an object of the present invention to provide a method for preparation of a sub-micron composition suitable for treatment of organic and inorganic substrates, or at least to provide the public with a useful choice.

### SUMMARY OF INVENTION

In a first aspect, the invention provides a method of preparing a composition comprising sub-micron particles, containing or coated with an active agent(s), the method comprising at least the steps of:
a) (i) dispersing sub-micron particles in a solvent(s);
(ii) adding to the dispersion, a formulation containing the active agent(s) dissolved in a suitable solvent in a manner sufficient to achieve substantial uniformity of the mixture (or vice versa); or
b) dispersing sub-micron particles in a solvent(s) whilst concurrently or sequentially dissolving a active agent(s) in said solvent in a manner sufficient to achieve substantial uniformity of the mixture; then
c) altering the physicochemical environment within the dispersion to cause the active agent to fall out of solution as a sub-micron layer in or on the sub-micron particles.

Preferably the active agent is a biocide, colouring agent and/or a water repellent agent.

Preferably all steps are conducted at a point of high shear.

Preferably the alteration in physicochemical environment can be one or more of: change in pH, introduction of another moiety which reacts with the active agent to cause precipitation, heating which can change the isoelectric point, heating which can remove sufficient solvent such that the solubility product of the active agent is exceeded, addition of a non-solvent of the active agent to cause precipitation or addition of a solute which causes precipitation of the active agent or other physicochemical process which destabilises the solubility of the biocide.

Preferably the pH of step (a) (ii) or (b) is adjusted to ensure the appropriate active agent species is formed.

Preferably the physicochemical environment is altered while agitating the result of step (a) (ii) or (b) such that the biocide precipitates as a sub-micron layer on the sub-micron particles and/or within any porosity in the sub-micron particles.

Preferably the sub-micron particle dispersion includes water.

Preferably the sub-micron particle consists of a soft material to enable subsequent wet or dry milling.

Preferably, the sub-micron particles are natural or synthetic organic or inorganic clays.

Preferably the natural clays are selected from any one or more of montmorillinite, hectorite, smectite, bentonite, halloysite, talcite, and allophane.

More preferably, the particles are selected from any one or more of halloysite, allophane or hectorite.

Preferably the sub-micron particles are insoluble in the solvent(s).

Preferably the solvents are selected from any one or more of water and organic solvents or mixtures thereof.

Preferably the solvent(s) are miscible.

Alternatively solvent(s) are immiscible.

Preferably one or more of the solvents can be in a super critical state.

Preferably one or more of the solvents can be a super critical solvent in admixture with a co-solvent.

Preferably the solvent in the super critical state is carbon dioxide.

Preferably the co-solvent is acetone, methanol, ethanol, or isopropanol.

Preferably one or more solvents can be removed and/or recovered, for example, by air drying or vacuum distillation.

Preferably the biocides are deposited as mono or poly-molecular layers in or on the sub-micron particles.

Preferably a chelating agent, dispersant and/or surfactant is added during or after the addition of the active agent composition to the sub-micron particle dispersion.

Preferably the sub-micron dispersion is added to the active agent composition.

Preferably the sub-micron composition may subsequently be concentrated by centrifugation.

Preferably the dispersants are well known to those versed in the art and can include the likes of polyacrylates or comb surfactants. Preferably the surfactants can include one or more of anionic, non-ionic or cationic surfactants depending on the specific biocide used.

Preferably in some instances the sub-micron particles are pre-treated to remove trace metals.

Preferably pre-treatment to remove trace metals includes use of a chelating agent.

Preferably pre-treatment involves acidification to change the surface charge.

If preferred the composition can be further milled in a form containing one or more solvents.

If preferred the composition is milled in dry form after the solvent or solvents have been removed.

If preferred, surfactants or dispersants can be added at any time or to any component used in the preparation of the composition.

Preferably an aqueous solution of a metal salt is added.

Preferably the metal salt is a salt of a biologically active metal. Most preferably the biologically active metal is copper, zinc or the like or mixtures thereof.

Preferably the biologically active metal is present as a chelate.

Preferably the chelate of said metals species can include 8-hydroxyquinoline, pyridinethione, 1,10-phenanthroline, N-nitrosolated cyclohexylhydroxylamine, amidoxamine, hydroxamic acid, thiohydroxamic acid, N-nitrosyl alkylhydroxylamine and the like.

Preferably subsequent to physicochemical alteration the metal salt is in an insoluble form, such as hydroxides, carbonates or mixed species thereof.

Preferably the pH of the composition containing the biocide is adjusted prior to addition to the sub-micron particles using an acid or base.

Preferably the pH of the composition containing the biocide is adjusted subsequent to addition to the sub-micron particles using an acid or base.

Preferably the pH is adjusted with a base such as ammonia, an amine or solution of an alkali. Where preferred such bases can be in the form of a hydroxide or salt of a weak acid such as carbonic acid.

Preferably in some instances the sub-micron particles are chemically modified.

Preferably one or more additional biocides are added concurrently or sequentially to the first prepared biocide sub-micron particles.

Preferably the sub-micron particles are peptised.

Preferably the sub-micron particles are peptised using polyacrylates, polyphosphates, pyrophosphates or the like.

Preferably the sub-micron particles are peptised using polyacrylates, polyphosphates, pyrophosphates or the like.

Preferably one or more additional biocides are applied to the coated surface of the particle.

Preferably the one or more additional biocides may or may not react with the already applied biocide.

Preferably the added organic biocide is in an organic solvent solution.

Preferably the organic biocide added is selected from any one or more of chlorothalonil, lodopropynylbutylcarbamate, or the like.

Preferably the organic biocide added is selected from any one or more insecticides such as bifenthrin, deltamethrin, permethrin, imidacloprid or the like.

Preferably the organic biocide added is selected from any one or more bactericides.

Preferably in some instances the composition may include an herbicide.

Preferably the organic solvent is soluble or miscible in water. More preferably the solvent is an alcohol, a ketone, a lactam, glycol ether or the like.

Preferably the organic solvent is immiscible in water.

Preferably the organic solvent is xylene

Preferably the solvent is recovered by vacuum distillation.

Preferably the solvent is recovered by vacuum distillation, more preferably such recovery can be facilitated by use of RF energy.

Preferably solvent is recovered during the process of applying the biocide species to the substrate.

Preferably the sub-micron biocides is dewatered to form more concentrated slurry or dried to form a powder.

Preferably soluble ions such as chloride, nitrate, sulphate, sodium, potassium and the like are removed by dialysis or by centrifugation and washing.

In one aspect, the composition is a sub-micron composition that includes sub-micron particles containing and/or coated with basic copper carbonate and tebuconazole or propiconazole, or a combination thereof.

In another aspect, the composition is a sub-micron composition that includes sub-micron particles containing and/or coated with basic copper carbonate or cupric hydroxide and chlorothalonil.

In another aspect, the composition is a sub-micron composition that includes sub-micron particles containing and/or coated with an insecticide such as Bifenthrin and which composition is used for treating plants or included in a resin used in preparation of plywood or laminated veneer lumber.

Preferably, the composition is a biocidal composition. Alternatively, the composition may impart properties such as colour or water repellence to at least a target zone of the substrate.

Preferably, the substrate to be treated is organic.

Preferably in some circumstances, the substrate is concrete or stone.

Preferably the composition is applied to the substrate by dipping, deluging, spraying, brushing or mixing. Additionally, variations of vacuum or positive pressure impregnation is used.

Preferably, the composition is applied at ambient temperature.

Preferably, the composition is stable at the temperature of the substrate at the time of application.

In another broad aspect, the invention provides a substrate to which a composition has been delivered in accordance with a method of the invention.

In another aspect the invention is a sub-micron formulation when produced by a process according to the first aspect of the invention.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

These and other aspects of the present invention, which should be considered in all its novel aspects, will become apparent from the following description, which is given by way of example only.

### FIGURES

FIG. 1 shows an SEM of the particles from Example 2.

FIG. 2 shows an SEM of the particles from Example 4.

### DESCRIPTION OF INVENTION

The following is a description of the preferred forms of the present invention given in general terms in relation to the sub-micron composition of the invention and the application of the novel method. While the description focuses particularly on the delivery of compositions to lumber, plants, leather, paint and the like, it should be appreciated that the method may be applicable to other substrates, such as stone, concrete and the like.

The invention in general terms relates to sub-micron compositions, and methods of preparing such compositions, for the treatment of substrates particularly against biological degradation or biological pests. Alternatively, the composition may impart properties such as colour or water repellence to at least a target zone of the substrate. The disclosure of the invention will refer to the use of the invention with the preferred active agent—biocide. It is to be understood that this reference is not intended to be limiting as use of other active agents (eg colouring and water repellent agents) could also be used.

In particular, the invention relates to methods for preparing compositions to treat lignocellulosic substrates, such as lumber, to treat plants including food crops, to treat other biologically degradable substrates including leather, inorganic substrates such as concrete and non-biological substrates such as paint. The compositions may be for the purpose of prevention of growth of pest organisms such as unwanted plant species, or for providing specific properties to the substrate, for example.

The inventors have unexpectedly discovered that sub-micron particulate biocides can be prepared simply and effectively by direct precipitation from aqueous, semi-aqueous or non-aqueous solutions into, or onto the surface of, sub-micron particles of clays or other insoluble sub-micron particles.

Such particles need not require polymers or surfactants or other expensive ancillary materials, although these can be added if advantageous. Such particles can be manufactured using simple inexpensive plant and equipment without use of expensive milling equipment, without incurring high energy costs or cooling costs, without the need for large volumes of solvents or surfactants and can conveniently be manufactured in smaller manufacturing units either near to or at the place of final use.

Precipitation of the biocide, on to the sub-micron particulate is achieved by altering the physicochemical properties of the dispersion containing the particulates. This can be achieved by a variety of means including one or more of; change in pH, introduction of another moiety which reacts with the biocide or pro-biocide to cause precipitation, heating which can change the isoelectric point, heating which can remove sufficient solvent such that the solubility product of the biocide is exceeded, addition of a non-solvent of the biocide to cause precipitation or addition of a solute which causes precipitation of the biocide or any other physicochemical process which destabilises the solubility of the biocide. This forms a layer of biocide in or on the original sub-micron particles in the dispersion.

For example, when using biologically active metals (eg copper), pH change or addition of excess hydroxide ions for example which would make cupric hydroxide, pH change plus excess carbonate ions which would make copper carbonate. If a protein were present heating could cause denaturing and encourage precipitation, heating might otherwise cause evaporation of an already concentrated solution thus causing precipitation. Addition of water (i.e. a non-solvent) to an ethanolic solution of a biocide otherwise not soluble in water would cause precipitation. Addition of a reactive biocide species (eg sodium salt of a biocide) to an acid salt of another biocide could cause precipitation by double decomposition. Altering the physicochemical environment within the dispersion by such methods causes the biocide to fall out of solution resulting in a sub-micron layer in or on the sub-micron particles. The physicochemical alteration (i.e. the pH change, temperature change etc) required to cause the precipitation and deposition onto the particulate would depend on the initial dispersion characteristics. For example, if copper bisquinolinolate was dissolved in sulphuric acid, addition of sodium hydroxide or other suitable base would initiate precipitation as the pH increased above 3. But the situation might be different if a weak acid and weak base were involved, or a weak acid and a strong base for that matter. Also the pH at which biocides become insoluble will vary from biocide to biocide (or any other means of precipitation). Once in possession of the invention, as described in this specification, such matters would be within the abilities of a skilled person.

The pH is preferably adjusted with a suitable acid (e.g. HCl, H₂SO₄, or the like) or a suitable base such as ammonia, an amine or solution of an alkali such as sodium hydroxide. Such bases can be in the form of a hydroxide or salt of a weak acid such as carbonic acid.

The pH of the composition containing the biocide will preferably be between about 3.5 and 8.5, more preferably between about 4 and 7.5 and can be adjusted into that range prior to addition to the sub-micron clay particles using an acid or base. Optionally, the pH of the composition containing the biocide is adjusted subsequent to addition to the sub-micron clay particles using an acid or base.

Further, because the biocide is present within the particle and/or as a layer on the surface of the particle, perhaps only one or two molecules thick, the composition has excellent bioavailability, and when an organism such as a fungus attempts to sequester the active ingredient, far greater amounts of sequestering agent are required. This may prove insurmountable to the organism, which thus succumbs to the biocide.

Therefore, in general terms, the invention relates to methods of preparing a composition comprising sub-micron particles containing within, or coated with, biocides, for the treatment of substrates against biological degrade or biological pests. The invention also relates to sub-micron compositions comprising sub-micron particles containing within, or coated with, biocides, for the treatment of substrates against biological degrade or biological pests.

The method allows for absorption onto or absorption into the sub-micron particles by a composition resulting in a sub-micron particulate biocide without the necessity of having to mill or grind the biocide or use significant quantities of ancillary surfactants or dispersants. Further the sub-micron particulate biocide composition can be free of solvents if preferred as solvents can be removed by methods known to the skilled person.

The invention is not a micronised composition, nor is it prepared by a micronising process. However, because some biocides are hard and difficult to mill, if they are prepared as micron or sub-micron particles in or on a soft sub-micron particulate particles, such as suitable clay particles, according to this invention, they can subsequently be milled to finer particles. This is possible because, in a preferred form, the sub-micron particles are soft allowing for further milling. A person skilled in this art would be aware of particles that are “soft” thus allowing further milling to occur. Thus this secondary milling process is not directly milling of the biocide but milling or fracturing of the softer sub-micron substrate, and forms an additional aspect of the invention.

The method of the invention may be used to deliver a wide range of biocides to a sub-micron particulate material, such as clay, resulting in a sub-micron particulate biocide. The resulting sub-micron particulate biocide can be a mobile fluid, slurry or a dry powder. It can also be converted to granules. The final composition is preferably an aqueous fluid and has active components which are non-volatile at the temperature at the time of application. Compositions of the invention may contain polar and/or non-polar solvents and the like, and surfactants or dispersants, both of which are not necessary in the art but may be used to impart particular properties to the final biocide composition when required. Persons of general skill in the art to which the invention relates will no doubt appreciate various compositions that may be applicable to the invention. However, by way of example, impregnation of lumber might be achieved by a variation of vacuum or pressure of a fluid containing the biocide of this invention. Alternatively a plant might be sprayed with a fluid containing the biocide of this invention. Where it is desired that the substrate has water repellent properties or is of a particular colour, compositions may include a waterproofing substrate or dyes or pigments of different colours, respectively.

Whilst not wishing to be bound by any particular theory, the inventors believe that the invention works through the creation of sub-micron particulate biocides, by absorption into or adsorption onto the surface of sub-micron particulate clay particles as monoatomic or poly-atomic layers. In the case of clay particles, such as synthetic hectorite, this should give disc-shaped sub-micron particles with a thickness of about 2 to 5 nm and a diameter of about 36 to 42 nm. In the case of halloysite clay particles, the sub-micron particles are rod shaped with a length of about 300 nm and a diameter of about 20 nm. In the case of allophone the particles will be spherical in shape with a diameter of about 50 nm. Examples of such biocidal sub-micron particles are shown in the appended Scanning Electron Micrographs.

As used herein, “substrate” should be taken to mean any organic or inorganic material which may be in need of delivery of a composition of some nature; for example for the purposes of protection or treatment to prevent or ameliorate the growth of pest organisms. Such an organic substrate is preferably lignocellulosic, such as wood products, lumber or logs, or plants or leather for example. The invention may be applicable to substrates which are inorganic such as concrete, stone, or metals.

The particulate compositions can be added to a carrier of choice. The particulate compositions are substantially insoluble in water and other low polarity solvents at ambient temperature and neutral pH so such options are available. Alternatively, other options in which the compositions will be substantially insoluble under similar conditions could be used, such as petroleum/plant based oils. It is an option for the carrier to also include a further active agent in solution or suspension form. The composition can be used for treating substrates such as plants or the composition can be included in products such as resins that can be used in preparation of plywood or laminated veneer lumber. Use of active agents such as Bifenthrin can be used in such applications. Alternative applications/uses of the compositions according to the invention are also intended to be included.

The biocide may be selected from fungicides such as the group comprising benzimidazoles, substituted morpholines, triazoles (which can include the likes of propiconazole, tebuconazole, hexaconazole and others), diazoles (which can include the likes of prochloraz), phthalonitriles, quaternary ammonium compounds, isothiazolinones, guazatines, dodine, methylene bisthiocyanate, orthophenylphenol, tertiary amine oxides (such as alkyldimethyl amine oxide), iodine containing fungicides, organic chelate complexes of metals, precursors of such organic complexes of metals, metal ions (e.g. Co 2 or 3; Cu 1 or 2; Zn 2), inorganic boron compounds and other acid stable fungicides, so long as they can be dissolved in the solvent system of the art by direct dissolution or pH manipulation. The biocide may also be selected from insecticides such as the group of synthetic pyrethroids (such as bifenthrin, delatmethrin, permethrin and the like) or imidacloprid. Other suitable options, such as pro-biocides which convert into active biocides, will be known to those versed in the art.

Alternative (or additional) active agents to biocides include, for example, colouring and water repellent agents. Colouring agents can be selected from dyes and pigments for example. Water repellent agents can be selected from silicones and waxes for example. Alternative options known to the skilled person could also be used.

The sub-micron particles are preferably natural or synthetic organic or inorganic clays. The natural clays may be selected from any one or more of montmorillinite, hectorite, smectite, bentonite, halloysite, talcite, and allophone. The synthetic clays may be selected from any one or more of halloysite, allophane or hectorite. Such selections are not intended to be limiting and any suitable clay particles as would be known to the skilled person could be used. It is however preferred that the sub-micron particles are insoluble in the solvent(s) used in the composition. In addition, in some instances, the sub-micron particles may also be chemically modified. In some instances the sub-micron particles could be pre-treated to remove trace metals, for example by use of a suitable chelating agent. The chelating agent could be added during or after the addition of the biocide composition to the clay dispersion.

Such pre-treatment of the sub-micron particles could also include acidification to change the surface charge of the particle. Further, the sub-micron particles could be peptised using polyacrylates, polyphosphates, pyrophosphates or the like prior to addition/adhesion of the biocide.

Preferably the solvents used for the biocide formulation in the sub-micron composition are selected from any one or more of water and organic solvents or mixtures thereof, such as alcohol, a ketone, a lactam, a glycol ether or the like. It is preferred that the organic solvent is immiscible in water however miscible solvents could also be used. Preferably the organic solvent is xylene. The solvents may be added at a temperature higher than ambient but below the boiling point of the solvent(s) used if desired. One or more of the solvents could be in a super critical solvent in admixture with a co-solvent such as acetone, methanol, ethanol, or isopropanol. Preferably the solvent in the super critical state is carbon dioxide.

Additionally, surfactants or dispersants can be added at any time or to any component used in the preparation of the composition. Preferably the dispersant or surfactant is added to any of the components prior to or subsequent to addition of the biocide formulation to the submicron particulate dispersion. Such dispersants are well known to those versed in the art and can include the likes of polyacrylates or comb surfactants. Surfactants can include one or more of anionic, non-ionic or cationic surfactants depending on the specific biocide used.

As will be apparent to the skilled person once in possession of this invention, the sub-micron dispersion can added to the biocide composition or vice versa.

The sub-micron particles can be dispersed in a suitable solvent or solvents for the active agent(s) to be used. A formulation containing the active agent(s) also dissolved in a suitable solvent(s) can then be added to the dispersion in a manner sufficient to achieve substantial uniformity of the mixture (or vice versa). Alternatively the sub-micron particles can be dispersed in the solvent(s) whilst concurrently or sequentially dissolving an active agent in the solvent(s) in a manner sufficient to achieve substantial uniformity of the mixture. Therefore an option is simply to disperse the particulate in a suitable solvent(s) for the active agent and then add the active to the dispersion.

The mixing of the two components (the particulate dispersion and the biocide formulation) should be done in such a manner as to ensure a high level of uniformity of the subsequent mixture. Substantial uniformity is preferred to ensure that as much of the composition as possible takes part in the process thus maximising efficiency. This can be done by agitation using vigorous shaking or mixing at high shear for example. High shear might for example take place in a ball mill or a Silverson. Such options would be known to a skilled person in the art.

It is also possible to add an aqueous solution of a metal salt to the composition. Preferably this metal salt will be a salt of a biocidally active metal such as copper, zinc or the like or mixtures thereof. The metal can be present as a chelate, such as 8-hydroxyquinoline, pyridinethione, 1,10-phenanthroline, N-nitrosolated cyclohexylhydroxylamine, amidoxamine, hydroxamic acid, thiohydroxamic acid, N-nitrosyl alkylhydroxylamine and the like.

The metal salt may also be in an insoluble form, such as hydroxides, carbonates or mixed species thereof, particularly if the composition is subjected to physiochemical alteration.

It is also possible for one or more additional biocides to be added to the composition if desired. The additional biocide(s) can added concurrently or sequentially to the first prepared biocide sub-micron particles. Preferably the added biocide will be an organic biocide in an organic solvent solution and can be selected from any one or more of chlorothalonil, lodopropynylbutylcarbamate, or the like; from any one or more insecticides such as bifenthrin, deltamethrin, permethrin, imidacloprid or the like; or any one or more standard bactericides or herbicides as may be desired for inclusion. These solutions/dispersions could be subjected to physiochemical alteration or could remain in the composition as a separate active phase.

In a preferred form of the process of the invention the solvent(s) used will be recovered for both cost and environmental reasons. Preferably the solvent is recovered by vacuum distillation, which can be facilitated by use of RF energy. Alternatively, or additionally, air drying could also be used. In a preferred form, the solvent is recovered during the process of applying the biocide species to the sub-micron substrate.

Soluble ions that may remain in the composition such as chloride, nitrate, sulphate, sodium, potassium and the like can be removed by dialysis or by centrifugation and washing.

The sub-micron biocides can be dewatered to form more concentrated slurry or dried to form a powder. The sub-micron biocide composition may be concentrated by centrifugation. The concentrated or dried biocide can then be reconstituted in a suitable carrier.

The invention may also be seen to extend to compositions that include sub-micron particles containing and/or coated with basic copper carbonate and tebuconazole or propiconazole, or a combination thereof; that include sub-micron particles containing and/or coated with basic copper carbonate or cupric hydroxide and chlorothalonil or that include sub-micron particles containing and/or coated with an insecticide such as Bifenthrin and which composition might be used for treating plants or included in a resin used in preparation of plywood or laminated veneer lumber. Reference to examples 10 and 19 herein indicate that such compositions also exhibit surprising levels of stability.

Various combinations of actives can of course also be used, such as cupric hydroxide or cupric oxide and tebuconazole or propiconazole; basic copper carbonate or cupric hydroxide and chlorothalonil. Alternatively single actors could of course be used (for example basic copper carbonate and/or cupric oxide.

The composition will preferably be a biocidal composition. Alternatively (or additionally), the composition may impart properties such as colour or water repellence to at least a target zone of the substrate.

Preferably the composition is applied to the substrate by dipping, deluging, spraying, brushing or mixing. Additionally, variations of vacuum or positive pressure impregnation may be used. The composition is ordinarily applied at ambient temperature and the composition should be stable at the temperature of the substrate at the time of application.

The invention may also be seen to extend to a substrate to which a composition has been delivered in accordance with a method of the invention. Further, the invention may also be a sub-micron formulation when produced by a process according to the first aspect of the invention.

The invention therefore provides a method of preparing a composition comprising sub-micron particles, containing or coated with a biocide(s), the method comprising at least the steps of:
a) (i) dispersing sub-micron particles in a solvent(s);
(ii) adding to the dispersion a formulation containing the biocide(s) dissolved in a suitable solvent; or
b) dispersing sub-micron particles in a solvent(s) whilst concurrently or sequentially dissolving a biocide in said solvent; and
c) altering the physicochemical environment within the dispersion to cause the biocide to fall out of solution as a sub-micron layer in or on the sub-micron particles.

It is an option for steps (a) (i) and (ii) to be combined or reversed. It is also an option to adjust the physiochemical environment (e.g. pH) of the formulation containing the active agent prior to addition to the sub-micron particle dispersion in step (a) (ii).

The steps of (a) (ii), (b) and (c) should preferably be undertaken so as to maximise uniformity of the resultant fluid (e.g. by agitation or conditions of high shear).

In one preferred embodiment, the method comprises at least the steps of:
a) dispersing sub-micron particles in water, an organic solvent or mix thereof;
b) adding to the sub-micron dispersion, at a point of reasonably high shear, a formulation containing the biocide dissolved in a suitable solvent;
c) if required adjusting pH to ensure the appropriate biocide species is formed;
d) if required adding a chelating species, anionic species or cationic species to ensure the appropriate biocide species is formed;
e) agitating the sub-micron biocide/dispersion until stability and uniformity is achieved;
f) precipitation of the biocide into, or on, the surface of the sub-micron particles.

Those versed in the art will appreciate when the above order may be changed to suit specific circumstances. For example, the order a) and b) can readily be reversed or the biocide and sub-micron clay may be concurrently or sequentially dispersed in a suitable solvent prior to alteration of the physicochemical environment to cause precipitation of the biocide onto the sub-micron particles.

In particular, the invention provides a method for preparing thermodynamically stable compositions containing unstable components. It is clearly desirable to be able to use compositions containing active agents and to be able to store such compositions for later use.

Sub-micron compositions according to the invention surprisingly show adequate stability characteristics for periods in excess of 12 months.

For example, even under ambient conditions copper (II) hydroxide (also known as cupric hydroxide) is thermodynamically unstable relative to decomposition to copper (II) oxide. This inherent instability complicates the manufacture, distribution and storage of copper (II) hydroxide and compositions containing it and has resulted in a number of approaches being developed to address the problem (refer: WO 2006/028853 the disclosure of which is incorporated herein in its entirety). The present invention provides sub-micron particulate compositions including cupric hydroxide which are stable for in excess of 12 months (refer: Examples 10 and 19 herein). Stable compositions containing inherently unstable actives such as copper (II) hydroxide as described herein therefore form an aspect of the invention as do methods of preparing stable compositions incorporating such actives.

The invention therefore includes stable sub-micron compositions including an active agent in a sub-micron layer in or on sub-micron particles and includes methods for preparing such stable compositions. In particular, the invention relates to stable sub-micron compositions comprising sub-micron particles containing within, or coated with, a sub-micron layer of a biocide(s), for the treatment of substrates against biological degradation or biological pests. The components of the stable compositions can be as described previously herein but, in a particularly preferred form, the biocide is cupric hydroxide.

However, in some preferred embodiments the sub-micron compositions can contain cupric oxide. In which case, strong heating to between about 40° C. and about 60° C., of the sub-micron composition including cupric hydroxide will yield a sub-micron composition comprising cupric oxide. Such compositions can also be prepared by using an elevated temperature in step (c) of the process of the invention.

As used herein, a “sub-micron particle” is any particle having no dimension on any one side which is greater than or equal to one micron. The term “sub-micron particle” would be known to a person skilled in the art and would be generally accepted to mean between 1 micron and 0.01 micron in size. “Dispersion” is a homogeneous fluid or powder wherein one or more biocides are dispersed substantially uniformly throughout the sub-micron particles and throughout the powder or fluid containing the sub-micron particles therein. Persons of general skill in the art to which the invention relates will readily appreciate the meaning of sub-micron, dispersion, biocide, fluid, powder, solvent, and the like.

In a preferred embodiment of the invention, a dispersion of sub-micron clay particles is prepared in water to which is then added a biocide in solution under conditions of high shear, following which the biocide is precipitated and transferred into the clay particle and/or onto the clay particle surface. If desired, the solvents used can then be removed and recovered.

The resultant biocidal composition may be applied to a surface of the substrate to be treated with the composition or to the interior of the substrate to be treated with the composition using any known means of bringing a composition into contact with a material. By way of example, the composition may be applied by dipping, deluging, spraying, or brushing or variations of vacuum/pressure impregnation. A wide range of vacuum/pressure schedules are known including Reuping process, Lowry process, Bethel process, vacuum/vacuum process and many variations of these.

The invention has the ability to use simple processing techniques without excessive capital expenditure and without high energy costs otherwise incurred with micronising techniques. It also negates the need of expensive dispersants, solvents, and surfactants which otherwise add cost without adding biological performance. This is because essentially only the sub-micron clay particles and the consequent sub-micron biocide need be retained in the final composition. Thus this invention may offer additional advantages over traditional processes.

### EXAMPLES

The invention will now be further described with reference to the following non-limiting examples.

### Example 1

### Copper Carbonate

Many organic substrates are susceptible to attack by pest organisms. There are recognised problems associated with cost and corrosivity of treating some such substrates. For example preserving lumber with soluble copper species in the presence of ammonia or amines carries the cost penalty from the ammonia or amines themselves. Further, because the copper is soluble severe corrosion occurs to metals in contact with the preservative. Thus using traditional preservatives necessitates use of fittings and fixtures made of stainless steel and these can be much more expensive than mild steel.

Attempts have been made to mitigate the corrosion issue for example replacing chloride present in earlier version of preservative with carbonate. This is incompletely successful because copper is still present in soluble form.

In experiments leading to the invention, the inventor carried out studies on a number of biocide compositions to determine if sub-micron biocidal particles could be created simply and effectively. In addition potential effects of corrosion were also determined.

A dispersion of synthetic Hectorite was prepared in water resulting in a clear fluid. To this was added a solution of cupric sulphate in water. The mixture was agitated to produce a translucent fluid which did not produce any precipitate and which remained stable for at least one year. To a sample of this was added a mild steel coupon to check corrosivity. Immediately copper plated onto the steel sample indicating that soluble reactive copper species existed in the fluid.

To the translucent fluid was added an aqueous solution of sodium carbonate with good agitation. As the pH was raised insoluble copper species precipitated from solution with the formation of very fine slurry. This slurry remained stable for at least 1 week without any settling or agglomeration.

2 g of synthetic Hectorite was dispersed in 198 g water. Hectorite is known to form disc like sub-micron particles with dimensions of 2 nanometer thickness and 30 nanometer diameter. This had a pH of 8.5. 22 g cupric sulphate pentahydrate was dissolved in 178 g water. This had a pH of 3.7. The two solutions were combined with vigorous agitation resulting in a translucent fluid with pH 4.5. This corroded steel. To the translucent fluid was added 6 g sodium carbonate slowly with vigorous agitation. This produced a fine dispersion of basic copper carbonate with pH was 8.5. A sample of this in water did not cause copper plating of a mild steel coupon. After a period of hours it was clear some iron was entering solution but not by displacement of copper, likely because of the resultant sodium sulphate formed by displacement of sulphate from the cupric sulphate. A further dilution was prepared and 0.1 g sodium nitrite was added. No apparent copper plating occurred and no apparent iron entered the solution after 1 week.

On the basis of this experimentation, the inventors learned that such a simple process could prepare sub-micron biocide compositions in a fashion which offered a number of benefits, namely:
The biocide composition fluid is stable without settling or agglomeration and which readily dispersed either as a slurry or upon further dilution with water
The biocide composition does not require the addition of dispersants or surfactants and in this case any solvent other than water
By raising the pH subsequent to preparation of the dispersion insoluble copper species are formed which do not interact with mild steel and any interaction of other components can be mitigated buy addition of a simple inhibitor.

Further, the inventors are aware that current biocide technology cannot provide such simple sub-micron species without use of expensive equipment, dispersants, considerable energy or use of expensive solvents.

The inventors have concluded that a process or method described herein may offer a practical and inexpensive alternative which can offer the user an effective alternative.

### Example 2

### Cupric Hydroxide

A sample was prepared by dispersing 2 g synthetic hectorite plus 2 g cupric sulphate in 100 ml water for 30 minutes. The pH was slowly raised to 7.5 with sodium hydroxide solution to form a sub-micron substrate coated with cupric hydroxide. A small aliquot was removed and added to clean water to yield a very fine dispersion in water.

The remaining fluid was centrifuged and washed with fresh water three times to yield a readily dispersible blue opaque fluid.

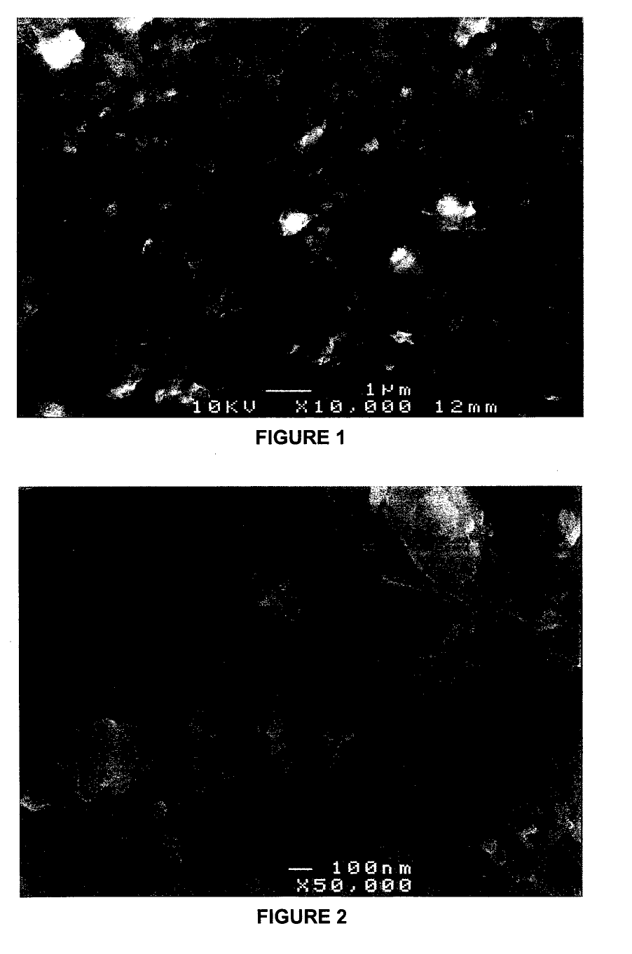

A scanning electron micrograph of the sub-micron particles is shown in FIG. 1.

### Example 3

### Cupric Hydroxide

A sample was prepared by dispersing 2 g synthetic hectorite peptised using sodium pyrophosphate plus 2 g cupric sulphate in 100 ml water for 30 minutes. The pH was slowly raised to 7.5 with sodium hydroxide solution to form a sub-micron substrate coated with cupric hydroxide. A small aliquot was removed and added to clean water to yield a very fine dispersion in water.

The remaining fluid was centrifuged and washed with fresh water three times to yield a readily dispersible blue opaque fluid.

### Example 4

### Cupric Hydroxide

Cupric hydroxide is thermodynamically unstable, that is it converts to cupric oxide over time or with heating. This effect is exacerbated at high pH. Therefore variations in the ratio of sub-micron substrate to copper were made and pH was carefully controlled.

22 g cupric sulphate was dispersed in water together with 4 g halloysite using a Silverson for 30 minutes. The halloysite had rod like shape with dimensions of approximately 20 nanometers diameter and 300 nanometers in length. Sodium hydroxide was slowly added until the pH was between 7.3 and 7.5. This formed a fine pale blue dispersion. The dispersion was centrifuged and washed with fresh water three times to remove residual sodium sulphate. The final slurry was placed in a closed container in an oven at 54 Celsius for 1 week. The cupric hydroxide coated sub-micron particles remained stable. A similar sample was stored at ambient temperature for 2 months with no visible change.

Precipitation occurs by abstraction of the sulphate by the sodium hydroxide and with a pH increase causes precipitation of cupric hydroxide.

A scanning electron micrograph of the sub-micron particles is shown in FIG. 2.

With reference to FIGS. 1 and 2, scanning electron microscopy (SEM) indicates that the particle size of the sub-micron Hectorite based product (FIG. 1) range from 10 nm up to around 50 nm with some agglomerated particles in the order of 500 nm, whereas the particle size of the sub-micron halloysite based product (FIG. 2) range from 100 nm to 1000 nm.

### Example 5

A sub-sample from Example 4 was air dried. After transferring to a small holding container a sub-sample of the dry material was dispersed in water. The dispersion occurred readily.

### Example 6

### Propiconazole

Recognising that biocides based on copper alone may not be sufficient for some purposes, the inventor set out to study whether the invention was applicable to other biocides. The first choice was propiconazole, a triazole, because this is frequently used as a co-biocide with copper.

Solution 1 was 1 g Hectorite was dispersed in 99 g water. Solution 2 was 1 g propiconazole was dissolved in 20 g acetone. With vigorous agitation solution 2 was added drop wise to solution 1. This produced a very slightly cloudy slightly viscous translucent fluid which remained stable for at least 1 week. Upon dilution in water this produced a practically clear fluid and which did not produce any precipitation.

The propiconazole is precipitated by a miscible non-solvent for the propiconazole (i.e. proiconazole soluble in acetone but not water).

### Example 7

This study was then conducted to look at the combination of two biocides.

A copper containing preservative was selected as the primary biocide because solutions of this metal are commonly used as lumber preservatives. Propiconazole as prepared in Example 2 was then added to a sample of Example 1. This appeared similar to Example 1. A sample of this was then diluted in water to give a translucent pale dispersion of copper species together with a dispersion of propiconazole.

The results of this study demonstrates that a combined particulate biocide similar to alternative art containing copper species and a triazole can be prepared by simple inexpensive technology without the need for costly or potentially hazardous additives.

### Example 8

### Permethrin

A further dispersion of Hectorite in water was prepared. To this was added a solution of the insecticide permethrin in acetone. Upon vigorous agitation a cloudy translucent dispersion was formed. Upon dilution in water this too resulted in a slightly cloudy translucent dispersion.

### Example 9

To a sample from Example 8 was added a small quantity of a fatty alcohol ethoxylate surfactant. This retained the same appearance as in Example 4. When diluted with water however, the fluid became practically transparent. Thus the combination of sub-micron clay coated with permethrin becomes more disperse in the presence of such surfactant.

### Example 10

Cupric hydroxide and synthetic Hectorite stability.

If allowed to settle the dispersion of Cu(OH)2 will readily re-disperse without recourse to any additional surfactants or dispersants. A sample from Example 2 was stored for 12 months allowing a fine gel like floc to form. Upon inversion the sub-micron particles immediately redispersed.

### Example 11

### Chlorothalonil

2 g of chlorothalonil plus 2 g synthetic hectorite in acetone was dispersed for 20 minutes using a laboratory Silverson. As water was slowly added and mixing continued small samples were removed and dropped into clean water. Initially each drop formed a fine cloudy suspension upon impact with the water however at addition of around 35 ml of water; drops of the fluid formed an immediate transparent liquid with water.

### Example 12

### Chlorothalonil

A quantity of the sample prepared as in Example 11 was placed in a Rotovap and all acetone removed. This formed a concentrated aqueous fluid. Upon further drying to remove much of the water a viscous gel resulted which readily redispersed in water.

### Example 13

### Chlorothalonil

To a sample from Example 11 was added 2% nonlylphenolethoxylate (9 eo) plus a small quantity of water to reduce viscosity. After mixing an aliquot of this in water formed a transparent fluid.

### Example 14

### Bifenthrin

2 g of bifenthrin plus 2 g synthetic hectorite was dispersed in acetone for 20 minutes using a laboratory Silverson. As water was slowly and mixing continued small samples were removed and dropped into clean water. Initially each drop form a fine cloudy suspension upon impact with the water however at addition of around 35 ml of water drops of the fluid formed an immediate transparent liquid with water.

### Example 15

### Tebuconazole

1.5 grams of Hectorite was dispersed in 100 grams water. To this was added with high shear a solution of 1 gram tebuconazole in 20 grams acetone. A slightly viscous semitransparent fluid was produced which remained stable for one year. Upon dilution in water this produced a colloidal dispersion.

### Example 16

### Mixture of Cupric Hydroxide and Chlorothalonil

A mixture of the suspension formed in Example 4 above with the suspension formed in example 11 above was prepared. No reaction or instability was noted.

### Example 17

### Copper Bis, 8-quinolinolate

2 g copper bis-quinolinolate was dissolved in water by addition of a small amount of sulphuric acid to reduce the pH below 2.8. 2 g halloysite was added and the fluid dispersed using a Silverson for 30 minutes. The pH was gradually increased to 3.8 using sodium hydroxide solution. The copper bis-quinolinolate formed a fine dispersion on the halloysite particles.

Copper bis-quinolinolate is a hard material and difficult to mill to sub-micron form. When dispersed over the surface of soft sub-micron particles these may then be milled further to produce dispersions of very small particle size.

### Example 18

### Bifenthrin

Compared to example 14, bifenthrin was dispersed in acetone concurrently with synthetic hectore. 8 g Hectorite together with 6 g bifenthrin were dispersed in 100 ml acetone for 20 minutes. The dispersion was then placed in a rotovap together with a weighted Teflon bead and the solvent recovered under vacuum. The Teflon bead was inserted to keep the resulting material dispersed. This produced a fine granular white powder.

Addition of 3% of this powder to water with agitation resulted in a fine dispersion which remained stable without settling for at least 3 weeks.

Surprisingly this stable dispersion was prepared without addition of surfactants, dispersants or any other typical adjuvant.

### Example 19

### Cupric Hydroxide Stability Testing

A range of dispersions of cupric hydroxide were prepared including those shown in the SEM micrographs (FIGS. 1 and 2). Samples were tested according to FAO protocol (accelerated storage procedure, Method MT 46, involving heating at 54±2° C. for 14 days (see Manual on Development and Use of FAO Specifications for Plant Protection Products, Fifth Edition, January 1999, sections 3.6.2 and 5.1.5)) and showed no sign of decomposition.

In addition, samples of dispersions of cupric hydroxide prepared (Examples 2 and 10) have been stored under ambient conditions for 24 months. These remain stable dispersions with no degradation.

### Discussion

Because the sub-micron substrate to which the biocides, which may otherwise be difficult to mill, are appended is soft, it is amenable to further milling. Thus the sub-micron particles with adherent absorbed biocide layer may be milled further as dry powders or as dispersions or suspensions. In such processes the sub-micron biocide composition can be further reduced in particle size by fracturing the sub-micron substrate without the need to reduce the particle size of the biocide in its own right.

The inventor has concluded that a process or method described herein for preparing a sub-micron particulate biocide or biocide mixture can offer a practical and inexpensive alternative which can be applied to various substrates and more particularly to lumber, plants and the like and which can significantly reduce the cost of capital plant otherwise associated with such methods or at least offers an alternative.

Surprisingly because the biocides are dispersed at molecular levels in or on the sub-micron particles the biocides are readily accessible to target degrading microflora.

The products of the invention might conveniently be applied to organic (eg lumber) or inorganic (eg concrete) products by a wide variation of processes and might be applied to plants by dipping, spraying or by soil application.

Surprisingly, by using a process of the present invention, the inventor found a significant enhancement in biocide preparation which provides users a simple process free from expensive adjuvants and which incurs low capital cost. The enhanced composition observed by the inventor is believed to have both commercial and environmental beneficial consequences. If the preservative or biocide composition is able to treat the substrate without recourse to adjuvants the cost thereof is significantly reduced. This might also limit the need for solvents, dispersants and surfactants and this has an environmental benefit because of reduced risk of spill or loss into the environment.

The invention has been described herein, with reference to certain preferred embodiments, in order to enable the reader to practice the invention without undue experimentation. However, a person having an ordinary or general skill in the art will readily recognise that many of the components and parameters may be varied or modified to a certain extent without departing from the scope of the invention. Furthermore, titles, headings, or the like are provided to enhance the reader's comprehension of this document, and should not be read as limiting the scope of the present invention.

The entire disclosures of all applications, patents and publications, cited above and below, if any, are hereby incorporated by reference.

The reference to any prior art in this specification is not, and should not be taken as, an acknowledgment or any form of suggestion that that prior art forms part of the common general knowledge in the field of endeavour to which the invention relates in New Zealand or any other country. Throughout this specification, unless the context requires otherwise, the words “comprise”, “comprising” and the like, are to be construed in an inclusive sense as opposed to an exclusive sense, that is to say, in the sense of “including, but not limited to”.

1. A method of preparing a composition comprising sub-micron particles, containing or coated with an active agent(s), the method comprising at least the steps of:
a) (i) dispersing sub-micron particles in a solvent(s);
(ii) adding to the dispersion, a formulation containing the active agent(s) dissolved in a suitable solvent in a manner sufficient to achieve substantial uniformity of the mixture (or vice versa); or
b) dispersing sub-micron particles in a solvent(s) whilst concurrently or sequentially dissolving an active agent in said solvent in a manner sufficient to achieve substantial uniformity of the mixture; and
c) altering the physicochemical environment within the dispersion to cause the active agent to fall out of solution as a sub-micron layer in or on the sub-micron particles.

2. The method according to claim 1, wherein the active agent is a biocide, colouring agent or a water repellent agent or a mixture thereof.

3. The method according to claim 1, wherein the alteration in the physicochemical environment can be by one or more of; change in pH, introduction of another moiety which reacts with the active agent to cause precipitation, heating which can change the isoelectric point, heating which can remove sufficient solvent such that the solubility product of the active agent is exceeded, addition of a non-solvent of the active agent to cause precipitation or addition of a solute which causes precipitation of the active agent.

4. The method according to claim 1, wherein the physicochemical environment is altered while agitating the result of step (a) (ii) or (b) such that the active agent precipitates as a sub-micron layer on the sub-micron particles and/or within any porosity in the sub-micron particles.

5. The method according to claim 1, wherein the sub-micron particle dispersion includes water.

6. The method according to claim 1, wherein the sub-micron particles are selected from natural or synthetic organic or inorganic clays.

7. The method according to claim 6, wherein the natural clays are selected from any one or more of montmorillinite, hectorite, smectite, bentonite, halloysite, talcite, and allophone.

8. The method according to claim 1, wherein the solvents are selected from any one or more of water and organic solvents or mixtures thereof.

9. The method according to claim 1, wherein the solvent(s) are miscible.

10. The method according to claim 1, wherein solvent(s) are immiscible.

11. The method according to claim 1, wherein one or more of the solvents can be in a super critical state.

12. The method according to claim 11, wherein one or more of the solvents can be a super critical solvent in admixture with a co-solvent.

13. The method according to claim 11, wherein the solvent in the super critical state is carbon dioxide.

14. The method according to claim 12, wherein the co-solvent is selected from any one or more of acetone, methanol, ethanol, or isopropanol.

15. The method according to claim 1, wherein the solvents are removed and/or recovered by air drying or vacuum distillation.

16. The method according to claim 1, wherein the active agent is deposited as mono or poly-molecular layers in or on the sub-micron particles.

17. The method according to claim 1, wherein a chelating agent, dispersant and/or a surfactant is added during or after the addition of the active agent composition to the sub-micron particles.

18. The method according to claim 1, wherein the sub-micron composition formed is subsequently concentrated by centrifugation.

19. The method according to claim 1, wherein the sub-micron particles are pre-treated to remove trace metals.

20. The method according to claim 19, wherein pre-treatment to remove trace metals includes use of a chelating agent, or acidification to change the surface charge.

21. The method according to claim 1, wherein the submicron composition formed is milled in a form containing one or more solvents.

22. The method according to claim 1, wherein the submicron composition formed is milled in dry form after the solvent or solvents have been removed.

23. The method according to claim 1, wherein the active agent formulation is an aqueous solution of a biologically active metal.

24. The method according to claim 23, wherein the biologically active metal is copper or zinc or mixtures thereof.

25. The method according to claim 23, wherein the biologically active metal is present as a chelate.

26. The method according to claim 25, wherein the chelate of said biologically active metal is selected from 8-hydroxyquinoline, pyridinethione, 1,10-phenanthroline, N-nitrosolated cyclohexylhydroxylamine, amidoxamine, hydroxamic acid, thiohydroxamic acid, and/or N-nitrosyl alkylhydroxylamine.

27. The method according to claim 1, wherein the method includes adjusting the pH of the formulation containing the active agent prior to addition to the sub-micron particle dispersion in step (a) (ii).

28. The method according to claim 1, wherein step (c) includes adjusting the pH using an acid or base.

29. The method according to claim 1, wherein one or more additional active agents are added concurrently or sequentially to the first prepared sub-micron dispersion.

30. The method according to claim 1, wherein the sub-micron particles are chemically modified prior to use in the method.

31. The method according to claim 30, wherein the sub-micron particles are peptised.

32. The method according to claim 31, wherein the sub-micron particles are peptised using polyacrylates, polyphosphates, and/or pyrophosphates.

33. The method according to claim 1, wherein the active agent is an insecticide, bacteriocide or herbicide.

34. The method according to claim 33, wherein the active agent is selected from any one or more selected from any one or more of chlorothalonil, iodopropynyl butylcarbamate bifenthrin, deltamethrin, permethrin, or imidacloprid.

35. The method according to claim 8, wherein the organic solvent is xylene.

36. The method according to claim 1, wherein the solvent is recovered by vacuum distillation.

37. The method according to claim 36, wherein the solvent recovery is facilitated by use of RF energy.

38. The method according to claim 1, wherein the solvent is recovered during the process of applying the biocide species to a substrate.

39. A composition prepared according to the method of claim 1.

40. A stable sub-micron composition including sub-micron particles containing, or coated with, a sub-micron layer of at least one biocide, for the treatment of substrates against biological degradation or biological pests.

41. The sub-micron composition according to claim 40 wherein the biocide is cupric hydroxide.

42. The sub-micron composition according to claim 40 wherein the biocide is cupric hydroxide and tebuconazole or propiconazole or a combination thereof.

43. The sub-micron composition according to claim 40 wherein the biocide is basic copper carbonate.

44. The sub-micron composition according to claim 40 wherein the biocide is (i) basic copper carbonate and (ii) tebuconazole or propiconazole, or a combination thereof.

45. The sub-micron composition according to claim 40 wherein the biocide is cupric oxide.

46. The sub-micron composition according to claim 40 wherein the biocide is cupric oxide and tebuconazole or propiconazole or a combination thereof.

47. The sub-micron composition according to claim 40 wherein the biocide is (i) basic copper carbonate or cupric hydroxide and (ii) chlorothalonil.

48. The sub-micron composition according to claim 40 wherein the biocide is Bifenthrin.

49. The sub-micron composition according to claim 48 wherein the composition is used for treating plants or is included in a resin used in preparation of plywood or laminated veneer lumber.

50. A method of treating a substrate, wherein the composition of claim 40 is applied to a substrate by dipping, deluging, spraying, brushing or mixing, or vacuum or positive pressure impregnation.

51. The method according to claim 50, wherein the composition is applied to the substrate at ambient temperature.

52. The method according to claim 50, wherein the composition formed is applied to an organic or inorganic substrate.

53. The method according to claim 52 wherein the substrate is selected from any one or more of wood products, plants, leather, concrete, stone, or metals.
